(19) United States
(12) Patent Application Publication
(10) Pub. No.: US 2026/0330239 A1
(43) Pub. Date: Oct. 22, 2026

(54) REINFORCEMENT LEARNING DEVICE, REINFORCEMENT LEARNING METHOD, AND RECORDING MEDIUM

(71) Applicant: NEC Corporation, Minato-ku, Tokyo (JP)

(72) Inventors: Natsuhiko SATO, Tokyo (JP); Hiroshi YOSHIDA, Tokyo (JP)

(73) Assignee: NEC Corporation, Minato-ku, Tokyo (JP)

(21) Appl. No.: 19/104,773

(22) PCT Filed: Sep. 1, 2022
(86) PCT No.: PCT/JP2022/032905

§ 371 Date: Feb. 19, 2025

(51) Int. Cl. G06N 3/092

(52) U.S. Cl. CPC G06N 3/092

(57) ABSTRACT

To provide reinforcement learning suitable for a case where a single estimator is used, a reinforcement learning apparatus (1) includes: a setting section (11) that sets an initial value of a risk-corrected reward; a calculation section (12) that calculates a correction factor; an updating section (13) that updates the risk-corrected reward; an estimation section (14) that performs estimation to obtain an estimated risk-corrected reward by both a process of calculating the correction factor and a process of updating the risk-corrected reward; and a training section (15) that performs training based on the estimated risk-corrected reward.

### TECHNICAL FIELD

The present invention relates to a reinforcement learning apparatus, a reinforcement learning method, and a storage medium.

### BACKGROUND ART

In reinforcement learning, an agent that performs learning takes an action based on the observed environment. Then, the reinforcement learning is carried out by sequentially obtaining policies that increase expected values of rewards depending on the change in the environment caused by actions, for use in determination of actions based on the environment.

For example, an agent that moves a cart on which an inverted pendulum is placed will be described as an example. The agent is designed so that the longer the pendulum remains inverted, the higher reward the agent receives. The agent observes the position of the cart, the speed of the cart, the angle of the pendulum, and the angular speed of the pendulum, to control the cart in accordance with the observed results. In this case, the agent can increase the duration of the inverted state of the pendulum as a result of maximization of the expected value of the inverted period of time of the pendulum.

However, in this reinforcement learning, variations in reward are not taken into consideration. For example, in such an agent that moves a cart on which an inverted pendulum is placed, greater variations in the reward indicates that the duration of inverted state of the pendulum varies greatly. If the variations in the inverted duration of the pendulum is greater, it may occur that the lower 10% has a very short inverted duration, even if the inverted duration is on average long.

Therefore, reinforcement learning called risk-sensitive reinforcement learning (hereinafter, referred to as “risk-sensitive reinforcement learning”) is known in which the variation in reward is considered in association with a risk to take into account the variation in reward. The risk-sensitive reinforcement learning maximizes Q+βV, where Q is the expected value of reward, V is the variance of reward, and β is the risk preference/avoidance parameter. With this configuration, the risk-sensitive reinforcement learning can avoid (or enjoy preference by increasing the risk in the case of the parameter β>0) a small risk while increasing the expected value of reward.

For example, Non-Patent Literature 1 discloses a configuration in which, in risk-sensitive reinforcement learning, which requires estimation of both the expected value Q of reward and the variance V of reward, a new estimate updating method is used, assuming that the distribution of reward becomes a normal distribution. Non-Patent Literature 1 discloses a configuration in which a value of Q+βV is directly estimated by a single estimator by employing a new estimate updating method. Further, Non-Patent Literature 1 discloses, on the basis of numerical experiments, that even in a case where the distribution of reward does not become normal, training can be carried out in such a way that the amount of risk is estimated properly to some extent, although some deviations occur.

### CITATION LIST

### Non-Patent Literature

### [Non-patent Literature 1]

Delétang, Grégoire, et al, “Model-Free Risk-Sensitive Reinforcement Learning.”, 2021

### SUMMARY OF INVENTION

### Technical Problem

In the risk-sensitive reinforcement learning disclosed in this Non-Patent Literature 1, similarly to other risk-sensitive reinforcement learnings, training is carried out by maximizing Q+βV, where Q is the expected value of reward, V is the variance of reward, and β is the risk preference/avoidance parameter. Since Q is the expected value of reward, it has the dimension of reward, and since V is the variance, it has the squared dimension of the dimension of reward. Thus, β has the dimension that is the dimension of reward to the power of minus 1. Therefore, in the risk-sensitive reinforcement learning disclosed in the abovementioned Non-Patent Literature 1, if the environment varies, it occurs that the degree of risk consideration changes even with the same β.

For example, a case will be described in which an appropriate β is determined in one environment and the risk-sensitive reinforcement learning disclosed in Non-Patent Literature 1 is carried out in another environment in which the reward of β is doubled. In this case, Q in the another environment is only twice as large as Q in the one environment, whereas V in the another environment is four times as large as V in the one environment. Thus, it occurs that risk is avoided more strongly and the expected value of reward is neglected. At this time, if β is also ½ times as large as the dimension, training similar to the risk-sensitive reinforcement learning in the one environment can be carried out. However, there has been a problem in that the amount of reward obtained in the another environment cannot be known without carrying out the training.

In a case where Q and V are estimated independently, this problem can be solved by using the standard deviation σ=√V as the variations in reward. This is because the dimension of the expected value of reward matches the dimension of the variations in reward. In this case, if Q+cσ is maximized with c as the dimensionless risk preference/avoidance parameter, then the above problem does not occur. However, if one of Q and V is estimated, in other words, if one estimator is used, there is a problem in that such a method cannot be taken.

An example aspect of the present invention has been made in view of these problems, and an example object thereof is to provide reinforcement learning suitable for a case where a single estimator is used.

### Solution to Problem

A reinforcement learning apparatus in accordance with an example aspect of the present invention is a reinforcement learning apparatus configured to learn a policy for use in an agent that has taken an action based on an observation result of an environment to determine a next action to take, the apparatus including: setting means for setting an initial value of a risk-corrected reward that is a reward determined taking into account a risk; calculation means for calculating a correction factor based on (i) a predetermined parameter of a reward, the predetermined parameter being associated with the risk, and (ii) a difference between the risk-corrected reward and a reward obtained by taking the next action; updating means for updating the risk-corrected reward based on the risk-corrected reward, the correction factor, and the difference; estimation means for performing estimation to obtain an estimated risk-corrected reward by both a process of calculating the correction factor by the calculation means with use of the risk-corrected reward updated by the updating means, and a process of updating the risk-corrected reward by the updating means with use of the updated risk-corrected reward and the correction factor; and training means for performing training based on the estimated risk-corrected reward.

A reinforcement learning method in accordance with an example aspect of the present invention is carried out by a reinforcement learning apparatus configured to learn a policy for use in an agent that has taken an action based on observation result of an environment to determine a next action to take, the method including: setting an initial value of a risk-corrected reward that is a reward determined taking into account a risk; calculating a correction factor based on (i) a predetermined parameter of a reward, the predetermined parameter being associated with the risk, and (ii) a difference between the risk-corrected reward and a reward obtained by taking the next action; updating the risk-corrected reward based on the risk-corrected reward, the correction factor, and the difference; performing estimation to obtain an estimated risk-corrected reward by both a process of calculating the correction factor in the calculating with use of the risk-corrected reward updated in the updating, and a process of updating the risk-corrected reward in the updating with use of the updated risk-corrected reward and the correction factor; and performing training based on the estimated risk-corrected reward.

A storage medium in accordance with an example aspect of the present invention is a computer-readable storage medium storing a program for causing a computer to function as a reinforcement learning apparatus configured to learn a policy for use in an agent that has taken an action based on an observation result of an environment to determine a next action to take, the program causing the computer to function as: setting means for setting an initial value of a risk-corrected reward that is a reward determined taking into account a risk; calculation means for calculating a correction factor based on (i) a predetermined parameter of a reward, the predetermined parameter being associated with the risk, and (ii) a difference between the risk-corrected reward and a reward obtained by taking the next action; updating means for updating the risk-corrected reward based on the risk-corrected reward, the correction factor, and the difference; estimation means for performing estimation to obtain an estimated risk-corrected reward by both a process of calculating the correction factor by the calculation means with use of the risk-corrected reward updated by the updating means, and a process of updating the risk-corrected reward by the updating means with use of the updated risk-corrected reward and the correction factor; and training means for performing training based on the estimated risk-corrected reward.

### Advantageous Effects of Invention

According to an example aspect of the present invention, it is possible to provide reinforcement learning suitable for a case where a single estimator is use.

### BRIEF DESCRIPTION OF DRAWINGS

FIG. 1 is a block diagram illustrating the configuration of a reinforcement learning apparatus in accordance with a first example embodiment of the present invention.

FIG. 2 is a flowchart illustrating the flow of a reinforcement learning method in accordance with the first example embodiment of the present invention.

FIG. 3 is a block diagram illustrating the configuration of a reinforcement learning apparatus in accordance with a second example embodiment of the present invention.

FIG. 4 is a diagram illustrating the flow of data in a control section in accordance with the second example embodiment of the present invention.

FIG. 5 is a flowchart illustrating the flow of processing carried out by the reinforcement learning apparatus in accordance with the second example embodiment of the present invention.

FIG. 6 is a schematic diagram illustrating how an AGV in accordance with a third example embodiment of the present invention preforms reinforcement learning.

FIG. 7 is a block diagram illustrating the configuration of the AGV in accordance with the third example embodiment of the present invention.

FIG. 8 is a block diagram illustrating an example of the hardware configurations of the reinforcement learning apparatus and the AGV in accordance with the respective example embodiments of the present invention.

### EXAMPLE EMBODIMENTS

### First Example Embodiment

The following description will discuss a first example embodiment of the present invention in detail with reference to the drawings. The present example embodiment is a basic form of example embodiments described later.

### (Configuration of Reinforcement Learning Apparatus 1)

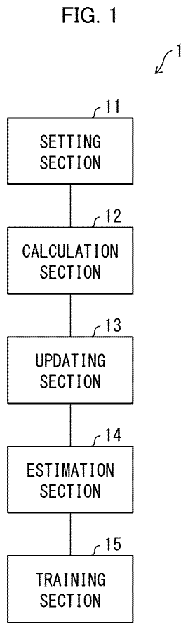

The following description will discuss the configuration of a reinforcement learning apparatus 1 in accordance with the present example embodiment with reference to FIG. 1. FIG. 1 is a block diagram illustrating the configuration of the reinforcement learning apparatus 1 in accordance with the present example embodiment.

The reinforcement learning apparatus 1 is an apparatus configured to learn a policy for use in an agent that has taken an action based on an observation result of an environment in which a reward follows a normal distribution, to determine a next action to take. As illustrated in FIG. 1, the reinforcement learning apparatus 1 includes a setting section 11, a calculation section 12, an updating section 13, an estimation section 14, and a training section 15. The setting section 11, the calculation section 12, the updating section 13, the estimation section 14, and the training section 15 are configured to realize setting means, calculation means, updating means, estimation means, and training means, respectively, in the present example embodiment.

The setting section 11 sets an initial value of a risk-corrected reward that is a reward determined taking into account a risk. The initial value of the risk-corrected reward is not particularly limited, and may be, for example, a random value, a value obtained by performing learning in a state where no risk correction is performed.

The risk-corrected reward is a value calculated by using the following Formula (1), assuming that the standard deviation of rewards is σ, a predetermined parameter is c, and the expected value of a reward to be obtained by taking the next action is μ.

ν=μ−cσ (1)

The calculation section 12 calculates a correction factor based on (i) a predetermined parameter of a reward, the predetermined parameter being associated with a risk, and (ii) a difference between the risk-corrected reward and a reward obtained by taking the next action.

Here, the predetermined parameter of the reward is a parameter of risk preference and avoidance of a real value set in advance.

Assuming that the reward obtained by taking the next action is r, the calculation section 12 calculates the difference δ by using the following Formula (2).

δ=r−ν (2)

Further, the calculation section 12 calculates the correction factor ξ by using the following Formulas (3) to (5).

$$f ( c ) = \frac{c}{c \cdot erf ( \frac{c}{\sqrt{2}} ) + \sqrt{\frac{2}{π}} exp ( - \frac{{c}^{2}}{2} )} \qquad ( 3 )$$

Here, erf is an error function. The calculation section 12 calculates the following Formula (4) as to predetermined parameter c.

$$a = ( \frac{1 + f ( c )}{1 - f ( c )} ) \qquad ( 4 )$$

Here, the correction factor ξ is expressed by the following Formula (5).

$${ξ}_{+} = \frac{2 α}{1 + {a}^{- sgn ( δ )}} \qquad ( 5 )$$

Here, sgn is a sign function.

That is, the calculation section 12 calculates the correction factor ξ by using the following Formula (6) in the case of δ>0 and by using the following Formula (7) in the case of δ<0.

$${ξ}_{+} = \frac{2 α}{1 + {a}^{- 1}} \qquad ( 6 )$$

$${ξ}_{-} = \frac{2 α}{1 + a} \qquad ( 7 )$$

The updating section 13 updates the risk-corrected reward based on the risk-corrected reward, the correction factor, and the difference.

Here, the updating section 13 updates risk-corrected reward ν by using the following Formula (8).

ν←ν+ξδ (8)

The estimation section 14 performs estimation to obtain an estimated risk-corrected reward by both a process of calculating the correction factor by the calculation section 12 with use of the risk-corrected reward updated by the updating section 13, and a process of updating the risk-corrected reward by the updating section 13 with use of the updated risk-corrected reward and the correction factor.

The training section 15 performs training based on the updated risk-corrected reward.

(Proof that Updating has Unique and Stable Fixed Point)

The following description will prove that if the reward is normally distributed, the updating of the risk-corrected reward has a unique and stable fixed point ν*, and the fixed point ν* coincides with μ+cσ.

The expression “updating has a unique and stable fixed point ν*” indicates that expected value J(ν) of the updating satisfies the following Formulas (9) to (11).

J(ν)<0 if ν>ν* (9)

J(ν)=0 if ν=ν*=μ+cσ (10)

J(ν)>0 if ν<ν* (11)

That is, it is indicated that, as to the expected value J(ν) of the updating, if the value of the estimated risk-corrected reward ν is greater than ν*, ν is updated so that the expected value becomes a smaller value. Further, it is indicated that, as to the expected value J(ν) of the updating, if the value of the estimated risk-corrected reward ν is less than ν*, ν is updated so that the expected value becomes a greater value. Furthermore, it is indicated that, as to the expected value J(ν) of the updating, the expected value of the amount of updating of ν becomes 0 if the value of the estimated risk-corrected reward ν is equal to ν*.

Here, if the abovementioned Formula (8) is rewritten using the following Formula (12), the following Formula (13) is obtained.

$$b = log ( \frac{1 + f ( c )}{1 - f ( c )} ) \qquad ( 12 )$$

$$v ← v + α \frac{2 δ}{1 + exp ( - b \cdot sgn ( δ ) )} \qquad ( 13 )$$

In Formula (13), the second term on the right-hand side indicates the amount of updating, so that the expected value of the amount of updating is given by Formula (14).

$$J ( v ) := 2 {\int }_{- ∞}^{∞} \frac{N ( x ; μ , {σ}^{2} ) ( x - v )}{1 + exp ( - b \cdot sgn ( x - v ) )} dx \qquad ( 14 )$$

Here, in Formula (14), if a variable transformation of ν=μ+tσ and ν→t is carried out, the following Formula (15) is obtained.

$$J ( v = μ + t σ ) = σ ( \frac{1}{1 + exp ( - b )} + \frac{1}{1 + exp ( b )} ) ( tanh \frac{b}{2} ( t \cdot erf ( \frac{t}{\sqrt{2}} ) + \sqrt{\frac{2}{π}} exp ( - \frac{{t}^{2}}{2} ) ) - t ) \qquad ( 15 )$$

Here, if Formula (15) and the following Formula (16) are used, J(ν*)=0, if ν=ν*=μ+cσ. Thus, Formula (10) is proved.

$$tanh \frac{b}{2} = f ( c ) \qquad ( 16 )$$

Further, J is continuous and differentiable for ν, and thus, dJ/dν<0. Thus, since J decreases monotonically in a narrow sense and since Formula (10) is proven, Formula (9) and Formula (11) are proven.

Thus, since the expected value J(ν) of the updating satisfies Formulas (9) to (11), the updating has a unique and stable fixed point ν*=μ+cσ.

As described in the foregoing, the reinforcement learning apparatus 1 in accordance with the present example embodiment employs a configuration in which the reinforcement learning apparatus 1 is configured to learn a policy for use in an agent that has taken an action based on an observation result of an environment to determine a next action to take, the apparatus including: the setting section (11) that sets an initial value of a risk-corrected reward that is a reward determined taking into account a risk; the calculation section (12) that calculates a correction factor based on (i) a predetermined parameter of a reward, the predetermined parameter being associated with the risk, and (ii) a difference between the risk-corrected reward and a reward obtained by taking the next action; the updating section (13) that updates the risk-corrected reward based on the risk-corrected reward, the correction factor, and the difference; the estimation section (14) that performs estimation to obtain an estimated risk-corrected reward by both a process of calculating the correction factor by the calculation section (12) with use of the risk-corrected reward updated by the updating section (13), and a process of updating the risk-corrected reward by the updating section (13) with use of the updated risk-corrected reward and the correction factor; and the training section (15) that performs training based on the estimated risk-corrected reward.

Therefore, according to the reinforcement learning apparatus 1 in accordance with the present example embodiment, even in two environments with different rewards, the predetermined parameter allows the degree of risk consideration to remain unchanged by using a risk-corrected reward. Therefore, according to the reinforcement learning apparatus 1 in accordance with the present example embodiment, it is possible to achieve an example advantage of being capable of providing reinforcement learning suitable for a case where a single estimator is used.

### (Flow S1 of Reinforcement Learning Method)

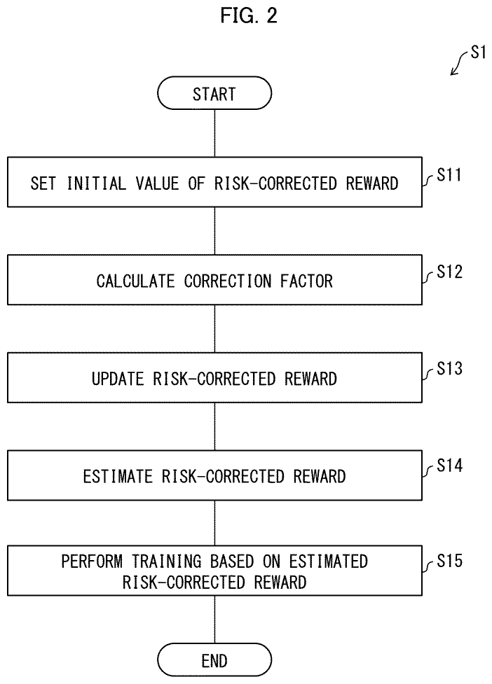

The following description will discuss a flow of a reinforcement learning method S1 in accordance with the present example embodiment with reference to FIG. 2. FIG. 2 is a flowchart illustrating the flow of the reinforcement learning method S1 in accordance with the present example embodiment.

### (Step S11)

In step S11, the setting section 11 sets the initial value of the risk-corrected reward that is a reward determined taking into account a risk.

### (Step S12)

In step S12, the calculation section 12 calculates a correction factor based on (i) a predetermined parameter of a reward, the predetermined parameter being associated with a risk, and (ii) a difference between the risk-corrected reward and a reward obtained by taking the next action.

### (Step S13)

In step S13, the updating section 13 updates the risk-corrected reward based on the risk-corrected reward, the correction factor, and the difference.

### (Step S14)

In step S14, the estimation section 14 performs estimation to obtain an estimated risk-corrected reward by both a process of calculating the correction factor by the calculation section 12 with use of the risk-corrected reward updated by the updating section 13, and a process of updating the risk-corrected reward by the updating section 13 with use of the updated risk-corrected reward and the correction factor.

### (Step S15)

In step S15, the training section 15 performs training based on the estimated risk-corrected reward.

As described in the foregoing, the reinforcement learning method S1 in accordance with the present example embodiment employs a configuration in which the method includes: setting, by the setting section 11, an initial value of a risk-corrected reward that is a reward determined taking into account a risk; calculating, by the calculation section 12, a correction factor based on (i) a predetermined parameter of a reward, the predetermined parameter being associated with the risk, and (ii) a difference between the risk-corrected reward and a reward obtained by taking the next action; updating, by the updating section 13, the risk-corrected reward based on the risk-corrected reward, the correction factor, and the difference; performing estimation, by the estimation section 14, to obtain an estimated risk-corrected reward by both a process of calculating the correction factor by the calculation section 12 with use of the risk-corrected reward updated by the updating section 13, and a process of updating the risk-corrected reward by the updating section 13 with use of the updated risk-corrected reward and the correction factor; and performing training, by the training section 15, based on the estimated risk-corrected reward. Thus, with the reinforcement learning method S1 in accordance with the present example embodiment, an example advantage similar to that of the abovementioned reinforcement learning apparatus 1 is brought about.

### Second Example Embodiment

The following description will discuss a second example embodiment of the present invention in detail with reference to the drawings. The same reference symbols are given to constituent elements which have functions identical to those described in the first example embodiment, and descriptions as to such constituent elements are omitted as appropriate.

### (Outline of Reinforcement Learning Apparatus 2)

A reinforcement learning apparatus 2 in accordance with the present example embodiment is an apparatus configured to learn a policy for use in an agent that has taken an action based on an observation result of an environment in which a reward follows a normal distribution, to determine a next action to take. As an example, the reinforcement learning apparatus 2 is an apparatus that performs learning based on an environment built in a simulator. Examples of simulations may include simulations of mobile robots, production and inventory management schedules, and AI for gamble, trade, and game.

### (Configuration of Reinforcement Learning Apparatus 2)

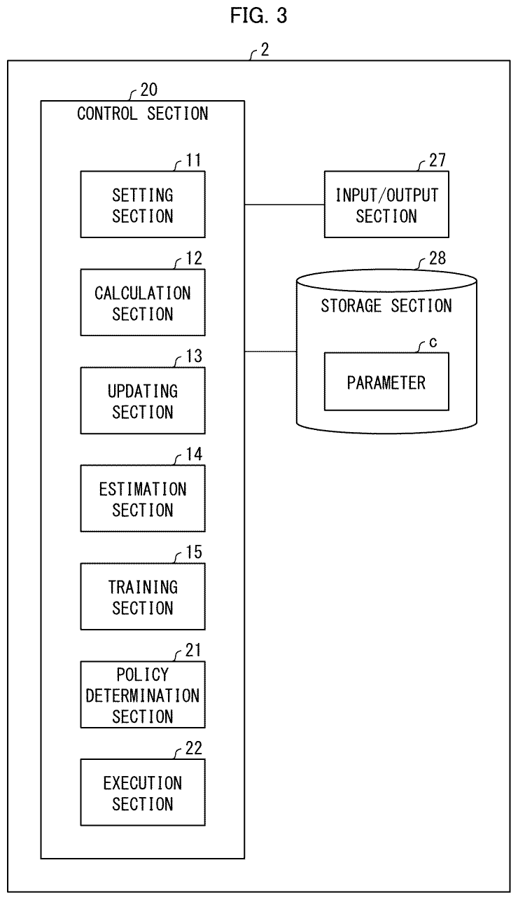

The following description will discuss the configuration of a reinforcement learning apparatus 2 in accordance with the present example embodiment with reference to FIG. 3. FIG. 3 is a block diagram illustrating the configuration of the reinforcement learning apparatus 2 in accordance with the present example embodiment. As illustrated in FIG. 3, the reinforcement learning apparatus 2 includes a control section 20, an input/output section 27, and a storage section 28.

The input/output section 27 is an interface for receiving data input and for outputting data. As an example, parameter c of a reward associated with a risk is inputted via the input/output section 27. The input/output section 27 provides the input data to the control section 20. The input/output section 27 outputs data provided from the control section 20 to another apparatus connected thereto. The parameter c is as described above as the predetermined parameter.

The storage section 28 stores data referred to by the control section 20. As an example the storage section 28 stores the parameter c.

### (Functions of Control Section 20)

The control section 20 controls constituent elements included in the reinforcement learning apparatus 2. As an example, the control section 20 obtains the parameter c provided from the input/output section 27, and stores the obtained parameter c in the storage section 28.

In addition, as illustrated in FIG. 3, the control section 20 functions as a setting section 11, a calculation section 12, an updating section 13, an estimation section 14, a training section 15, a policy determination section 21, and an execution section 22. The setting section 11, the calculation section 12, the updating section 13, the estimation section 14, and the training section 15 are configured to realize setting means, calculation means, updating means, estimation means, and training means, respectively, in the present example embodiment.

The setting section 11 sets an initial parameter with which the estimation section 14 to be described later estimates risk-corrected reward ν that is a reward determined taking into account a risk. For example, the setting section 11 may include the initial value of the risk-corrected reward ν and a weight of the neural network with which the estimation section 14 estimates the risk-corrected reward ν.

Further, the setting section 11 generates a state-action value function of array ν(S,A) of estimates of the risk-corrected reward of action a in state s.

The calculation section 12 calculates correction factor ξ based on parameter c, and difference δ between the risk-corrected reward ν and reward r obtained by taking the next action. The method of calculating the correction factor ξ may be a method using the abovementioned Formulas (3) to (5). The calculation section 12 also calculates correction factor ξ+ and correction factor ξ−. The method of calculating the correction factor ξ+ and the correction factor ξ− may be a method using the abovementioned Formulas (6) and (7).

The updating section 13 updates the risk-corrected reward based on the risk-corrected reward ν, the correction factor ξ, and the difference δ. The method of updating the risk-corrected reward ν may be a method using the abovementioned Formula (8). That is, the updating section 13 updates the risk-corrected reward ν by adding the risk-corrected reward ν to a value obtained by multiplying the correction factor ξ by the difference δ.

As an example, the updating section 13 calculates the difference δ using the following Formula (17).

δ=r+γν′(s′,a)−ν(s,a) (17)

where γ is the discount factor.

The estimation section 14 performs estimation to obtain an estimated risk-corrected reward ν by both a process of calculating the correction factor ξ by the calculation section 12 with use of the risk-corrected reward ν updated by the updating section 13, and a process of updating the risk-corrected reward ν by the updating section 13 with use of the updated risk-corrected reward ν updated by the updating section 13 and the correction factor ξ. As an example, the estimation section 14 may be estimation means having parameters such as a neural network.

The training section 15 performs training based on the updated risk-corrected reward. As an example, the training section 15 trains the policy determination section 21 to learn based on the updated risk-corrected reward ν.

The policy determination section 21 is caused to learn by the training section 15 to output the action a to be executed by the execution section 22, receiving the state s as input.

The execution section 22 executes the action a outputted from the policy determination section 21.

### (Flow of Data in Control Section 20)

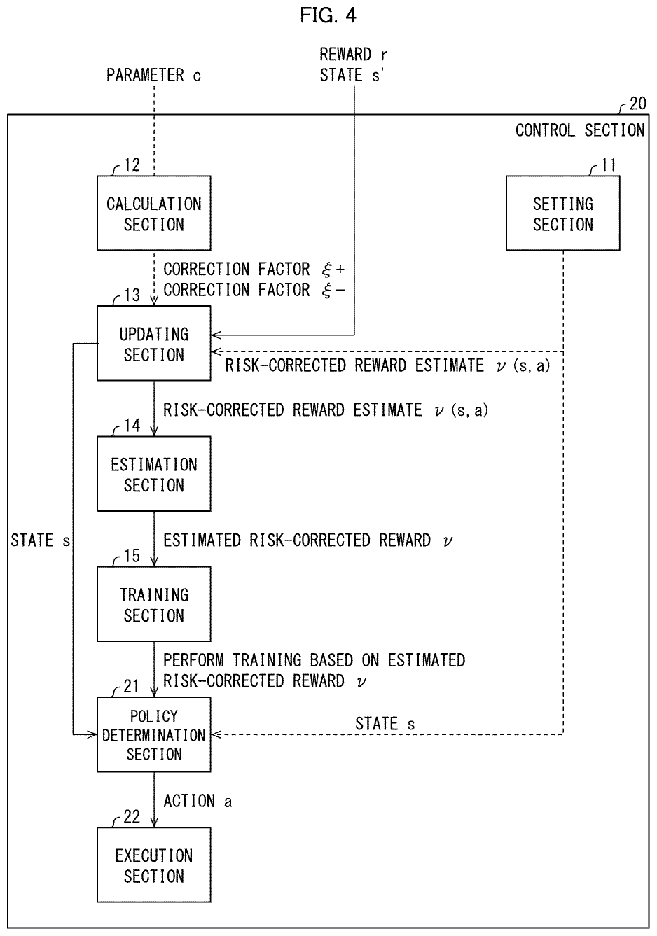

The following description will discuss the flow of data in the control section 20 with reference to FIG. 4. FIG. 4 is a diagram illustrating the flow of data in the control section 20 in accordance with the present example embodiment.

First, the data is processed as indicated by broken lines in FIG. 4. That is, the calculation section 12 obtains the parameter c and calculates the correction factor ξ+ and the correction factor ξ−. The calculation section 12 supplies the calculated correction factors ξ+ and ξ− to the updating section 13.

The setting section 11 generates a state-action value function of array ν(S,A) of estimates of the risk-corrected reward ν. The setting section 11 also sets risk-corrected reward estimate ν(s,a), which is a value of the risk-corrected reward in the case of the initial state s and the action a, as the initial value of the risk-corrected reward ν. The setting section 11 supplies the set risk-corrected reward estimate ν(s,a) to the updating section 13. The setting section 11 also supplies the state s to the policy determination section 21.

Subsequently, the data is processed as indicated by solid lines in FIG. 4. That is, the policy determination section 21 outputs the action a to the execution section 22. The execution section 22 executes the action a.

Then, upon execution of the action a by the execution section 22, the updating section 13 obtains the reward r. The updating section 13 also obtains the next state s′. Then, the updating section 13 calculates risk-corrected reward estimate ν(s′,a) of the next state s′ and the action a, and the difference δ.

The updating section 13 updates the risk-corrected reward ν, which is an estimator, based on the risk-corrected reward estimate ν(s,a), the difference δ, and the correction factors ξ+ and ξ−. Specifically, as described above, the updating section 13 updates the risk-corrected reward ν using one of the correction factor ξ+ and the correction factor ξ− depending on whether the difference δ is a positive number or a negative number. With this configuration, the updating section 13 can sequentially obtain superior estimators. In other words, the calculation section 12 calculates one of the correction factor ξ+ and the correction factor ξ− depending on whether the difference δ is a positive number or a negative number, and supplies the calculated correction factor to the updating section 13.

Then, the updating section 13 supplies the updated risk-corrected reward estimate ν(s,a) to the estimation section 14. The updating section 13 updates the state s and supplies the updated state s to the policy determination section 21.

The estimation section 14 obtains a plurality of risk-corrected reward estimates ν(s,a) by both a process of calculating the correction factor ξ by the calculation section 12 and a process of updating the risk-corrected reward estimate ν(s,a) by the updating section 13. Then, the estimation section 14 performs estimation to obtain estimated risk-corrected reward ν. The estimation section 14 supplies the estimated risk-corrected reward ν to the training section 15.

The training section 15 trains the policy determination section 21 to learn based on the estimated risk-corrected reward ν.

### (Flow S2 of Processing Carried Out by Reinforcement Learning Apparatus 2)

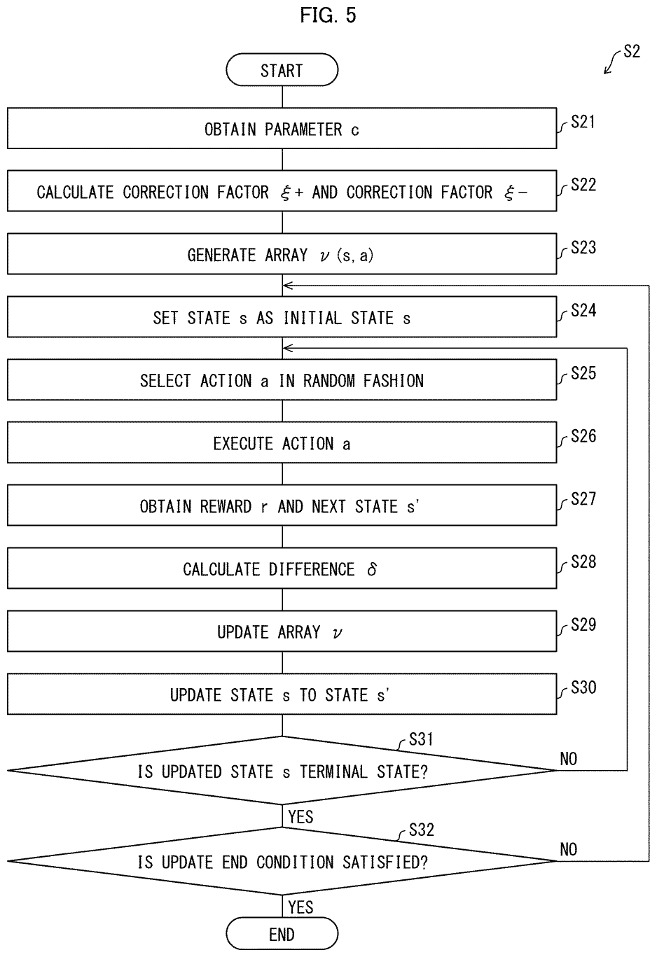

The following description will discuss a flow S2 of processing carried out by the reinforcement learning apparatus 2 with reference to FIG. 5. FIG. 5 is a flowchart illustrating the flow S2 of the processing carried out by the reinforcement learning apparatus 2 in accordance with the present example embodiment.

### (Step S21)

In step S21, the calculation section 12 obtains the parameter c stored in the storage section 28.

### (Step S22)

In step S22, the calculation section 12 calculates the correction factor ξ+ and the correction factor ξ− based on the parameter c. The calculation section 12 supplies the calculated correction factors ξ+ and ξ− to the updating section 13.

### (Step S23)

In step S23, the setting section 11 generates the array ν(S,A) in which an estimate of the risk-corrected reward in each state and each action is stored.

### (Step S24)

In step S24, the setting section 11 sets the state s to the initial state s. Then, the setting section 11 sets, as the initial value, the risk-corrected reward estimate ν(s,a) of the initial state s and the action a. The setting section 11 supplies the set risk-corrected reward estimate ν(s,a) to the updating section 13. The setting section 11 also supplies the state s to the policy determination section 21. That is, the reinforcement learning apparatus 2 starts simulating.

### (Step S25)

In step S25, the policy determination section 21 randomly selects the action a. For example, the policy determination section 21 may employ a configuration in which action a having the highest value is selected with probability 1−ε or a configuration in which random action a is selected with probability ε.

### (Step S26)

In step S26, the policy determination section 21 supplies the action a to the execution section 22. The execution section 22 executes the action a based on the action a supplied from the policy determination section 21.

### (Step S27)

In step S27, the updating section 13 obtains the reward r earned in response to the execution of the action a by the execution section 22, and the next state s′.

### (Step S28)

In step S28, the updating section 13 calculates the risk-corrected reward estimate ν(s′,a). Then, the updating section 13 calculates the difference δ using the abovementioned Formula (17).

### (Step S29)

In step S29, the updating section 13 calculates the risk-corrected reward estimate ν(s′,a) and updates the array ν(S,A).

### (Step S30)

In step S30, the updating section 13 updates the risk-corrected reward ν, which is an estimator, based on the risk-corrected reward estimate ν(s,a), the difference δ, and the correction factors ξ+ and ξ−, using Formula (8).

Here, as described above, the updating section 13 uses one of the correction factor ξ+ and the correction factor ξ− depending on whether the difference δ is a positive number or a negative number. In other words, the calculation section 12 calculates one of the correction factor ξ+ and the correction factor-depending on whether the difference δ is a positive number or a negative number, and supplies the calculated correction factor ξ+ or correction factor ξ− to the updating section 13.

Then, the updating section 13 updates the state s from the initial state s to the next state s′.

### (Step S31)

In step S31, the updating section 13 determines whether the updated state s is the terminal state.

In a case where it is determined in step S31 that the state is not the terminal state (step S31: NO), the reinforcement learning apparatus 2 returns to the process of step S25.

### (Step S32)

In a case where it is determined in step S31 that the state is the terminal state (step S31: YES), the updating section 13 determines in step S32 whether the update end condition is satisfied. As an example, the updating section 13 determines whether predetermined conditions such as the number of episodes and rewards are satisfied.

In a case where it is determined in step S32 that the end condition is not satisfied (step S32: NO), the reinforcement learning apparatus 2 returns to the process of step S24.

On the other hand, in a case where it is determined in step S32 that the end condition is satisfied (step S32: YES), the reinforcement learning apparatus 2 ends the processes illustrated in FIG. 5.

As described in the foregoing, in the reinforcement learning apparatus 2 in accordance with the present example embodiment, estimation of the risk-corrected reward can be carried out using a single estimator with use of the dimensionless parameter c. Therefore, in the reinforcement learning apparatus 2 in accordance with the present example embodiment, it is possible to achieve an example advantage of being capable of performing the risk-sensitive reinforcement learning with use of a single estimator and keeping the degree of consideration of risk unchanged despite change in the amount of reward.

In addition, the reinforcement learning apparatus 2 in accordance with the present example embodiment employs a configuration in which the apparatus performs learning based on an environment built in a simulator. Even with this configuration, an example advantage similar to that of the abovementioned reinforcement learning apparatus 1 can be achieved.

### Third Example Embodiment

A third example embodiment of the present invention will be described in detail with reference to the drawings. The same reference numerals are given to constituent elements which have functions identical to those described in the abovementioned example embodiments, and descriptions as to such constituent elements are not repeated.

### (Outline of AGV 3)

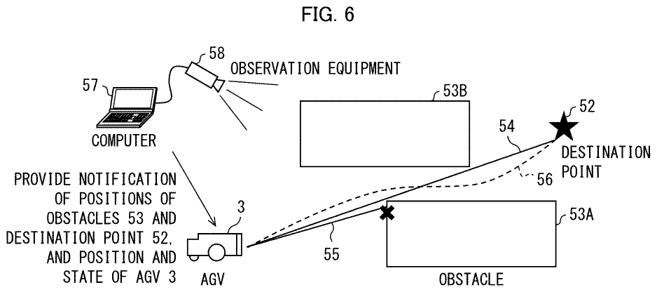

The outline of an automatic guided vehicle (AGV) 3 in accordance with the present example embodiment will be described with reference to FIG. 6. FIG. 6 is a schematic diagram illustrating how the AGV 3 in accordance with the present example embodiment performs reinforcement learning.

The AGV 3 in accordance with the present example embodiment is a mobile robot that takes an action using a policy or an estimated risk-corrected reward obtained by the reinforcement learning apparatus. For example, the AGV 3 may take an action using a policy or an estimated risk-corrected reward obtained by the reinforcement learning apparatus 2 described above.

As illustrated in FIG. 6, the AGV 3 takes an action using the policy or the estimated risk-corrected reward obtained by the reinforcement learning apparatus trained to reach a destination point 52 while avoiding obstacles 53 (obstacle 53A and obstacle 53B). The shorter the time to reach the destination point 52, the greater the reward. In addition, a penalty (negative reward) is given if the AGV 3 hits an obstacle 53.

The schematic diagram of FIG. 6 illustrates that observation equipment 58 observes the state of the AGV 3, the destination point 52, and the positions of the obstacles 53. The information observed by the observation equipment 58 is outputted to the AGV 3 via a computer 57 configured to be capable of communicating with the AGV 3. With this configuration, the AGV 3 can recognize its own state, the destination point 52, and the positions of the obstacles 53.

### (Configuration of AGV 3)

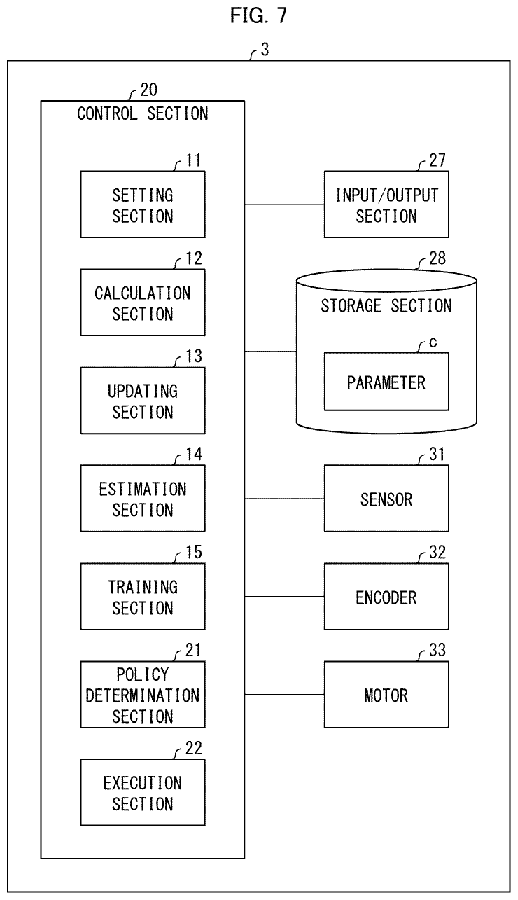

The configuration of the AGV 3 in accordance with the present example embodiment will be described with reference to FIG. 7. FIG. 7 is a block diagram illustrating the configuration of the AGV 3 in accordance with the present example embodiment.

As illustrated in FIG. 7, the AGV 3 includes a control section 20, an input/output section 27, a storage section 28, a sensor 31, an encoder 32, and a motor 33.

The control section 20 controls constituent elements included in the AGV 3. In addition, the control section 20 also functions as the setting section 11, the calculation section 12, the updating section 13, the estimation section 14, the training section 15, the policy determination section 21, and the execution section 22, as illustrated in FIG. 3. The setting section 11, the calculation section 12, the updating section 13, the estimation section 14, and the training section 15 are configured to realize setting means, calculation means, updating means, estimation means, and training means, respectively, in the present example embodiment. The functions of the control section 20 are the same as those of the control section 20 in the above example embodiment, and thus descriptions thereof are omitted.

The input/output section 27 and the storage section 28 are the same as those of the input/output section 27 and the storage section 28 in the above example embodiments, respectively, and thus descriptions thereof are omitted.

The sensor 31 obtains sensor information that indicates the state of the AGV 3. As an example, the sensor 31 may be an acceleration sensor that obtains sensor information that indicates an acceleration of the AGV 3.

The encoder 32 outputs the sensor information obtained by the sensor 31 to the control section 20 in the form of electrical signals.

The motor 33 is an electric motor configured to drive the AGV 3. As an example, the motor 33 may drive the AGV 3 based on instructions from the execution section 22 of the control section 20.

### (Processes Carried Out by AGV 3 and Example Advantages Thereof)

The AGV 3 performs reinforcement learning by setting, as the state s, the state of the AGV 3 itself obtained by the sensor 31 and the encoder 32, information observed by the observation equipment 58, and information of a map illustrated in FIG. 6.

For example, in FIG. 6, if the AGV 3 attempts to reach the destination point 52 in a short time, the risk of contacting the obstacles 53 and obtaining a negative reward increases. This increases variation in reward the AGV 3 obtains. In addition, if the AGV 3 attempts to reach the destination point 52 on the shortest route 54, an error might increase a risk that the AGV 3 follows a route 55 and contacts the obstacle 53A.

However, the AGV 3 performs reinforcement learning in consideration of such a risk. That is, instead of training the AGV 3 to increase only the expected value of the reward, the AGV 3 learns routes to the destination point 52 in consideration of both the reward earned in response to the arrival at the destination point 52 earlier and the reward in the event of a contact with the obstacles 53.

Therefore, the AGV 3 can more easily learn a policy of passing through a route, such as a route 56, which is indicated by a broken line, that allows a higher reward to be earned.

### Software Implementation Example

Some or all of the functions of each of the reinforcement learning apparatuses 1 and 2, and the AGV 3 may be implemented by hardware such as an integrated circuit (IC chip), or may be alternatively implemented by software.

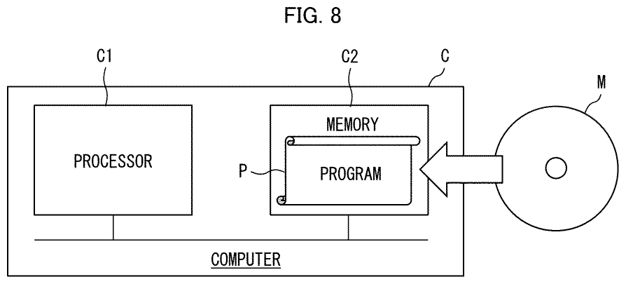

In the latter case, the reinforcement learning apparatuses 1 and 2, and the AGV 3 are implemented by, for example, a computer that executes instructions of a program that is software implementing the foregoing functions. FIG. 8 illustrates an example of such a computer (hereinafter, referred to as “computer C”). The computer C includes at least one processor C1 and at least one memory C2. The memory C2 stores a program P for causing the computer C to operate as the reinforcement learning apparatuses 1 and 2, and the AGV 3. The processor C1 of the computer C retrieves the program P from the memory C2 and executes the program P, so that the functions of the reinforcement learning apparatuses 1 and 2, and the AGV 3 are implemented.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. The memory C2 can be, for example, a flash memory, a hard disk drive (HDD), a solid state drive (SSD), or a combination of these.

Note that the computer C may further include a random access memory (RAM) in which the program P is loaded if the program P is executed and/or in which various kinds of data are temporarily stored. The computer C may further include a communication interface via which data is transmitted to and received from another apparatus. The computer C may further include an input/output interface for connecting the computer C to an input/output apparatus(es) such as a keyboard, a mouse, a display and/or a printer.

The program P can be recorded in a non-transitory tangible storage medium M from which the computer C can read the program P. The storage medium M can be, for example, a tape, a disk, a card, a semiconductor memory, a programmable logic circuit, or the like. The computer C can acquire the program P via the storage medium M. The program P can be transmitted via a transmission medium. The transmission medium can be, for example, a communications network, a broadcast wave, or the like. The computer C can acquire the program P also via such a transmission medium.

### Additional Remark 1

The present invention is not limited to the above example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

Some of or all of the foregoing example embodiments can also be described as below. Note, however, that the present invention is not limited to the following supplementary notes.

### Supplementary Note 1

A reinforcement learning apparatus configured to learn a policy for use in an agent that has taken an action based on an observation result of an environment to determine a next action to take, the apparatus including: setting means for setting an initial value of a risk-corrected reward that is a reward determined taking into account a risk; calculation means for calculating a correction factor based on (i) a predetermined parameter of a reward, the predetermined parameter being associated with the risk, and (ii) a difference between the risk-corrected reward and a reward obtained by taking the next action; updating means for updating the risk-corrected reward based on the risk-corrected reward, the correction factor, and the difference; estimation means for performing estimation to obtain an estimated risk-corrected reward by both a process of calculating the correction factor by the calculation means with use of the risk-corrected reward updated by the updating means, and a process of updating the risk-corrected reward by the updating means with use of the updated risk-corrected reward and the correction factor; and training means for performing training based on the estimated risk-corrected reward.

### Supplementary Note 2

The reinforcement learning apparatus according to Supplementary note 1, wherein the updating means updates the risk-corrected reward by adding the risk-corrected reward to a value obtained by multiplying the correction factor by the difference.

### Supplementary Note 3

A mobile robot that takes an action using the policy or the estimated risk-corrected reward obtained by the reinforcement learning apparatus according to Supplementary note 1 or 2.

### Supplementary Note 4

A reinforcement learning method carried out by a reinforcement learning apparatus configured to learn a policy for use in an agent that has taken an action based on observation result of an environment to determine a next action to take, the method including: setting an initial value of a risk-corrected reward that is a reward determined taking into account a risk; calculating a correction factor based on (i) a predetermined parameter of a reward, the predetermined parameter being associated with the risk, and (ii) a difference between the risk-corrected reward and a reward obtained by taking the next action; updating the risk-corrected reward based on the risk-corrected reward, the correction factor, and the difference; performing estimation to obtain an estimated risk-corrected reward by both a process of calculating the correction factor in the calculating with use of the risk-corrected reward updated in the updating, and a process of updating the risk-corrected reward in the updating with use of the updated risk-corrected reward and the correction factor; and performing training based on the estimated risk-corrected reward.

### Supplementary Note 5

A computer-readable storage medium storing a program for causing a computer to function as a reinforcement learning apparatus configured to learn a policy for use in an agent that has taken an action based on an observation result of an environment to determine a next action to take, the program causing the computer to function as: setting means for setting an initial value of a risk-corrected reward that is a reward determined taking into account a risk; calculation means for calculating a correction factor based on (i) a predetermined parameter of a reward, the predetermined parameter being associated with the risk, and (ii) a difference between the risk-corrected reward and a reward obtained by taking the next action; updating means for updating the risk-corrected reward based on the risk-corrected reward, the correction factor, and the difference; estimation means for performing estimation to obtain an estimated risk-corrected reward by both a process of calculating the correction factor by the calculation means with use of the risk-corrected reward updated by the updating means, and a process of updating the risk-corrected reward by the updating means with use of the updated risk-corrected reward and the correction factor; and training means for performing training based on the estimated risk-corrected reward.

### Additional Remark 3

Furthermore, some of or all of the above example embodiments can also be expressed as below.

A reinforcement learning apparatus configured to learn a policy for use in an agent that has taken an action based on an observation result of an environment to determine a next action to take, the apparatus including: a setting process of setting an initial value of a risk-corrected reward that is a reward determined taking into account a risk; a calculation process of calculating a correction factor based on (i) a predetermined parameter of a reward, the predetermined parameter being associated with the risk, and (ii) a difference between the risk-corrected reward and a reward obtained by taking the next action; an updating process of updating the risk-corrected reward based on the risk-corrected reward, the correction factor, and the difference; an estimation process of performing estimation to obtain an estimated risk-corrected reward by both a process of calculating the correction factor in the calculation process with use of the risk-corrected reward updated in the updating process, and a process of updating the risk-corrected reward in the updating process with use of the updated risk-corrected reward and the correction factor; and a training process of performing training based on the estimated risk-corrected reward.

Note that the reinforcement learning apparatus may further include a memory, which may store therein a program for causing the at least one processor to carry out the setting process, the calculation process, the updating process, the estimation process, and the training process. Alternatively, the program may be stored in a computer-readable, non-transitory, tangible storage medium.

Reference Signs List

| | |
|---|---|
| 1, | Reinforcement learning apparatus |
| 2 | |
| 3 | AGV |
| 11 | Setting section |
| 12 | Calculation section |
| 13 | Updating section |
| 14 | Estimation section |
| 15 | Training section |
| 21 | Policy determination section |
| 22 | Execution section |

What is claimed is:

1. A reinforcement learning apparatus configured to learn a policy for use in an agent that has taken an action based on an observation result of an environment to determine a next action to take, the apparatus comprising at least one processor, the at least one processor carrying out:
a setting process of setting an initial value of a risk-corrected reward that is a reward determined taking into account a risk;
a calculation process of calculating a correction factor based on (i) a predetermined parameter of a reward, the predetermined parameter being associated with the risk, and (ii) a difference between the risk-corrected reward and a reward obtained by taking the next action;
an updating process of updating the risk-corrected reward based on the risk-corrected reward, the correction factor, and the difference;
an estimation process of performing estimation to obtain an estimated risk-corrected reward by both a process of calculating the correction factor in the calculation process with use of the risk-corrected reward updated in the updating process, and a process of updating the risk-corrected reward in the updating process with use of the updated risk-corrected reward and the correction factor; and
a training process of performing training based on the estimated risk-corrected reward.

2. The reinforcement learning apparatus according to claim 1, wherein in the updating process, the at least one processor updates the risk-corrected reward by adding the risk-corrected reward to a value obtained by multiplying the correction factor by the difference.

3. A mobile robot that takes an action using the policy or the estimated risk-corrected reward obtained by the reinforcement learning apparatus according to claim 1.

4. A reinforcement learning method carried out by a reinforcement learning apparatus configured to learn a policy for use in an agent that has taken an action based on observation result of an environment to determine a next action to take, the method comprising:
setting an initial value of a risk-corrected reward that is a reward determined taking into account a risk;
calculating a correction factor based on (i) a predetermined parameter of a reward, the predetermined parameter being associated with the risk, and (ii) a difference between the risk-corrected reward and a reward obtained by taking the next action;
updating the risk-corrected reward based on the risk-corrected reward, the correction factor, and the difference;
performing estimation to obtain an estimated risk-corrected reward by both a process of calculating the correction factor in the calculating with use of the risk-corrected reward updated in the updating, and a process of updating the risk-corrected reward in the updating with use of the updated risk-corrected reward and the correction factor; and
performing training based on the estimated risk-corrected reward.

5. A non-transitory, computer-readable storage medium storing a program for causing a computer to function as a reinforcement learning apparatus configured to learn a policy for use in an agent that has taken an action based on an observation result of an environment to determine a next action to take,
the program causing the computer to function as:
setting means for setting an initial value of a risk-corrected reward that is a reward determined taking into account a risk;
calculation means for calculating a correction factor based on (i) a predetermined parameter of a reward, the predetermined parameter being associated with the risk, and (ii) a difference between the risk-corrected reward and a reward obtained by taking the next action;
updating means for updating the risk-corrected reward based on the risk-corrected reward, the correction factor, and the difference;
estimation means for performing estimation to obtain an estimated risk-corrected reward by both a process of calculating the correction factor by the calculation means with use of the risk-corrected reward updated by the updating means, and a process of updating the risk-corrected reward by the updating means with use of the updated risk-corrected reward and the correction factor; and
training means for performing training based on the estimated risk-corrected reward.
